(19) United States
(12) Patent Application Publication
(10) Pub. No.: US 2025/0242330 A1
(43) Pub. Date: Jul. 31, 2025

(54) USE OF VERBASCUM EXTRACT TO INCREASE OIL RETENTION CAPACITY OF MATERIALS

(71) Applicant: ISTANBUL TEKNIK UNIVERSITESI, Istanbul (TR)

(72) Inventors: Ismail KOYUNCU, Istanbul (TR); Omer KARA, Istanbul (TR); Borte KOSE MUTLU, Istanbul (TR); Bahar YAVUZTURK GUL, Istanbul (TR); Sevde KORKUT, Istanbul (TR); Irem Feyza CAMADAN, Istanbul (TR); Berra Sabire AYDIN, Istanbul (TR)

(73) Assignee: ISTANBUL TEKNIK UNIVERSITESI, Istanbul (TR)

(21) Appl. No.: 18/856,655

(22) PCT Filed: Mar. 21, 2023
(86) PCT No.: PCT/TR2023/050268

§ 371 Date: Oct. 14, 2024

(30) Foreign Application Priority Data
Apr. 13, 2022 (TR) 2022/005910

(51) Int. Cl. B01J 20/24

(52) U.S. Cl. CPC B01J 20/24; B01J 2220/485

(57) ABSTRACT

A use of Verbascum extract on various materials for the treatment of oil-grease, waste oil and petroleum derivatives and to increase the oil retention capacity of the material, is provided. The material is selected from objects of solid natural or synthetic polymers with a porous structure or high surface roughness, granules in bulk forming gaps, gels or cellulosic materials, fabrics, textiles or woven textile materials. The Verbascum extract is obtained with an aid of a homogenizer using a solvent selected from acetone, ethanol, and methanol.

### CROSS REFERENCE TO THE RELATED APPLICATIONS

This application is the national phase entry of International Application No. PCT/TR2023/050268, filed on Mar. 21, 2023, which is based upon and claims priority to Turkish Patent Application No. 2022/005910, filed on Apr. 13, 2022, the entire contents of which are incorporated herein by reference.

### TECHNICAL FIELD

The invention relates to the use of Verbascum extract in combination with various materials for the treatment of oil-grease, waste oil and petroleum derivatives in order to increase the oil retention capacity of the material.

### BACKGROUND

The cleaning and treatment of oil and grease and petroleum derivatives is an important and highly studied subject. Waste oils, petroleum and petroleum derivatives constitute significant problems for the environment as they are difficult to refine and clean. The difficulty and costliness of oil and grease cleaning in daily life, as well as the discharge of waste oils into the receiving environment without treatment, the spread of oil and its derivatives into surface waters due to accidents, etc., and the serious negative impact on aquatic life are problems that need to be solved. This pollution in surface waters affects other living organisms, including humans, through the food chain. Discharging waste oils into the receiving environment is an important problem, as well as transporting them to the treatment plant through the sewage system and treating them in the treatment plant are also important matters.

In the known state of the art, there are different methods for oil-grease and petroleum cleaning. These include mechanical cleaning, the use of absorbents, chemical dispersants, incineration and the use of microorganisms.

Mullein is the name given to the biennial plant species in the genus Verbascum. Verbascum L. (Scrophulariaceae), also known as mullein, has 360 species worldwide. Turkey has 249 species, 191 of which are endemic. Therefore, it is important to expand the usage areas of plant species that are abundant in our country. The most important reasons for working with Verbascum plant are that it can easily grow on its own with its seeds, it is easy to access because it is abundant in our country, it is not in the food chain and it is wild.

In the article with DOI number 10.1016/j.foodhyd.2018.02.050, in the known state of the art, it is mentioned that mullein plant species was used as an emulsion stabilizer, Soxhlet apparatus was used to obtain the plant extract and methanol was used as solvent.

In the International patent document numbered WO2017192109A1, which is in the known state of the technique, a soap composition and its production methods are mentioned. It is mentioned that Verbascum can be used.

However, the fields of use of the extract of the genus Verbascum in the sample documents are not similar to the invention in question. The purpose of using Verbascum extract in the subject invention is to increase the oil retention capacity of materials.

Some of the methods used for oil-grease and petroleum cleaning in the known state of the art and their disadvantages are listed in Table 1.

Table 2. In the known state of the art, these are the methods used to clean the oil in the desired environment and their disadvantages.

| Technique | Disadvantages |
|---|---|
| Incineration | Harmful gases are emitted into the atmosphere |
| | after incineration. |
| Chemical | They can cause toxic effects on the ecosystem. |
| Dispersants | Most of the oil dispersants currently in use |
| | are flammable. |
| Mechanical | Mechanical cleaning is effective for pollution |
| Cleaning | in calm seas. This is a limiting factor for |
| | the use of the method. |
| Adding | Reagents and fertilizers need to be added to |
| Microorganism | the contaminated water to facilitate the growth |
| | of the fungi and algae to be used. This causes |
| | extra costs. |
| Use of Synthetic | Synthetic sorbents are expensive and resistant |
| Sorbents | to biodegradation. Therefore, they cause |
| | environmental problems. |

New alternative methods attract attention due to the fact that the methods in the known state of the art are expensive, unsustainable and environmentally unfriendly. Plant-derived sorbents are a good alternative because of their low cost, availability and also their tendency to reduce the use of chemicals and cause less damage to the environment. Therefore, there is a need to use Verbascum extract to increase the oil retention capacity of these materials.

### SUMMARY

The purpose of the present invention is to obtain environmentally friendly materials for cleaning oil-grease and petroleum products from the desired environment in a sustainable manner and at low cost. For this purpose, a method in which Verbascum extract is added to the materials to be used to increase the oil retention capacity of the material and materials containing Verbascum extract according to this method have been developed.

### DETAILED DESCRIPTION OF THE EMBODIMENTS

The inventive method for increasing the oil retention capacity of absorbent materials, basically consis of exposing a material to Verbascum plant extract.

The absorbent material may consist of solid objects of natural or synthetic polymers with a porous structure or high surface roughness, bulk granules, gels or objects of cellulosic materials for use in the paper towel industry, fabrics, textiles or woven textiles. Absorbent material consisting of solid objects can be exposed to Verbascum extract by dipping or spraying, and absorbent material such as granules, gels or woven fibers can be exposed to Verbascum extract by spraying or mixing.

While the inventive method may be practiced using commercially available Verbascum extract, it preferably comprises the step of obtaining the Verbascum extract prior to exposing the material to the Verbascum extract. For this purpose, plants or plant parts of the genus Verbascum are applied to an extraction method in the presence of a solvent.

A model implementation of the invention is described as follows. Experiments demonstrating the effectiveness of the invention were also performed using materials with increased oil retention capacity with Verbascum extract obtained by this implementation.

Firstly, Verbascum extracts are obtained using different solvents. 5 grams of Verbascum was extracted with 100 ml each of acetone, ethanol and methanol solvents with the help of a homogenizer. The extract, solvent and plant mixture obtained as a result of the extraction process was filtered and solid plant parts were separated from the mixture. The mixtures were kept under fume hood and on heaters for 24 hours to allow the solvents to evaporate. The extracts taken from the heater were kept at 40° C.

In order to obtain the material with increased oil retention capacity with Verbascum extract and to assess the oil retention capacity of the obtained material, the steps were applied as follows:
dipping 0.19 g of sponge in the Verbascum extract obtained,
weighing after removing and squeezing the sponge,
dipping the sponge into a beaker with 20 mL of household oil,
re-weighing the sponge after it has been left in the beaker for a while.

In order to compare the oil retention capacity of the sponge dipped in Verbascum extract, 0.19 g sponge, which was not dipped in Verbascum extract, was also dipped into a beaker with 20 ml of domestic oil and weighed after waiting.

### Calculation of Oil Retention Capacity

W1: Weight of the sponge dipped in the extract
W2: Weight of sponge dipped in oil after the extract
W3: Weight of dry sponge dipped in oil
W4: Oil absorption capacity of the dry sponge
Ws: Weight of dry sponge
Ws=0.19 grams
W3=7.5 grams
Oil absorption capacity of dry sponge=W3−Ws=7.5 grams−0.19 grams=7.31 grams
Amount of oil absorbed per gram of sponge=7.31 grams/0.19 grams=38.47

### 1. Experiment Dipped in the Extract Obtained Using Methanol Solvent:

W1=0.56 grams
W2=10.30 grams
Amount of oil absorbed=10.30 grams−0.56 grams=9.74 grams
Amount of oil absorbed per gram of sponge=9.74 grams/0.19 grams=51.26
Amount of oil absorbed by the extract=Amount of oil absorbed−Oil absorption capacity of the dry sponge=9.74 gram−7.31 gram=2.43 gram
Weight of the extract in the sponge=W1−Ws=0.56 gram−0.19 gram=0.37 gram
Amount of Oil Held per Gram of Extract=2.43 grams/0.37 grams=6.56

### 2. Experiment Dipped in the Extract Obtained Using Ethanol Solvent:

W1=0.6 gram
W2=9.68 grams
Amount of oil absorbed=9.68 grams−0.60 grams=9.08 grams
Amount of oil absorbed per gram of sponge=9.08 grams/0.19 grams=47.78
Amount of oil absorbed by the extract=Amount of oil absorbed−Oil absorption capacity of dry sponge=9.08 grams−7.31 grams=1.77 grams
Weight of the extract in the sponge=W1−Ws=0.60 grams−0.19 grams=0.41 grams
Amount of oil held per gram of extract=1.77 grams/0.41 grams=4.32

### 3. Experiment Dipped in the Extract Obtained Using Acetone Solvent:

W1=0.53 grams
W2=8.24 grams
Amount of oil absorbed=8.24 grams−0.53 grams=7.71 grams
Amount of oil absorbed per gram of sponge=7.71 grams/0.19 grams=40.57
Amount of oil absorbed by the extract=Amount of oil absorbed−Oil absorption capacity of dry sponge=7.71 grams−7.31 grams=0.4 grams
Weight of the extract in the sponge=W1−Ws=0.53 grams−0.19 grams=0.34 grams
Amount of oil held per gram of the extract=0.4 grams/0.34 grams=1.18

Table 2. It shows how many times its own weight the sponge can hold oil.

| | Dry Sponge |
|---|---|
| Ws: Weight of the dry sponge | 0.19 |
| W3: Weight of the sponge dipped in oil | 7.5 |
| W4: Oil absorption capacity of the dry sponge | 7.31 |
| W4/W3: How many times the sponge's own | 38.47 |
| weight can hold oil | |

TABLE 3
It is a comparative table of the data according to solvents.

| | Methanol | Ethanol | Acetone |
|---|---|---|---|
| W1 = Weight of the sponge dipped | 0.56 | 0.6 | 0.53 |
| in the extract | | | |
| W2 = Weight of sponge dipped in oil | 10.30 | 9.68 | 8.24 |
| after the extract | | | |
| W0 = W2 − W1 (Amount of oil held) | 9.74 | 9.08 | 7.71 |
| W5 = W0 − W4 | 2.43 | 1.77 | 0.4 |
| W6 = W1 − Ws = Weight of the | 0.37 | 0.41 | 0.34 |
| extract in the sponge | | | |
| W5/W6 = How many grams of oil can 1 | 6.57 | 4.32 | 1.18 |
| gram of extract hold | | | |
| How many times its own weight in oil can | 51.26 | 47.78 | 40.57 |
| a sponge dipped in the extract hold? | | | |

In the experiments conducted within the scope of the research, it was observed that while the dry sponge could hold 38 times its own weight in oil, this value increased to 51, 47 and 40 times, respectively, when 5 grams of extract obtained by dissolving in methanol, ethanol and acetone were added to the sponge.

In addition, the extract obtained by dissolving in methanol solvent can hold 6.57 times its own weight of oil, while the extract obtained by dissolving in ethanol can hold 4.32 times its own weight and the extract obtained by dissolving in acetone can hold 1.18 times its own weight. As stated in the related studies, the herbal extract increased the oil adsorption capacity of the absorbent material from 38.47% to 51.26%. When the oil retention potentials were compared, it was determined that the use of methanol as a solvent was more effective.

The Verbascum extract obtained can be applied in all sectors. It can be used as a spray, absorbent and applied to all kinds of absorbent materials. For this purpose, it can be used with sponges, tissues, all kinds of polymers with absorbent materials, etc.

The advantages obtained by the method of increasing the oil retention capacity of materials with the developed Verbascum extract are listed as follows:
Verbascum extract is added to substances that do not have oil retention properties to provide oil retention properties or to increase this property of a substance with oil retention properties.
The general distribution area of Verbascum is Anatolia. The fact that 245 species are distributed in Turkey ensuring that the study is not dependent on foreign raw materials and domestic resources are used.
It can be used in all sectors as adsorption enhancer due to its low cost. Therefore, it allows the use of expensive and chemical adsorption materials to be reduced.

What is claimed is:

1. A method for increasing an oil retention capacity of an absorbent material, comprising exposing the absorbent material to a Verbascum plant extract.

2. The method according to claim 1, wherein the absorbent material is selected from objects of solid natural or synthetic polymers with a porous structure or high surface roughness, granules in bulk forming gaps, gels or cellulosic materials, fabrics, textiles or woven textile materials, and the absorbent material is exposed to the Verbascum plant extract by dipping or spraying.

3. The method according to claim 1, wherein the absorbent material is selected from granules in bulk forming gaps or gels, and the absorbent material is exposed to the Verbascum plant extract by spraying or mixing.

4. The method according to claim 1, wherein the Verbascum plant extract is obtained with an aid of a homogenizer using a solvent selected from acetone, ethanol, and methanol.

5. An absorbent material with an increased oil retention capacity obtained by the method according to claim 1.

6. The absorbent material with the increased oil retention capacity according to claim 5, wherein in the method, the absorbent material is selected from objects of solid natural or synthetic polymers with a porous structure or high surface roughness, granules in bulk forming gaps, gels or cellulosic materials, fabrics, textiles or woven textile materials, and the absorbent material is exposed to the Verbascum plant extract by dipping or spraying.

7. The absorbent material with the increased oil retention capacity according to claim 5, wherein in the method, the absorbent material is selected from granules in bulk forming gaps or gels, and the absorbent material is exposed to the Verbascum plant extract by spraying or mixing.

8. The absorbent material with the increased oil retention capacity according to claim 5, wherein in the method, the Verbascum plant extract is obtained with an aid of a homogenizer using a solvent selected from acetone, ethanol, and methanol.
